(19) United States
(12) Patent Application Publication
(10) Pub. No.: US 2009/0237256 A1
(43) Pub. Date: Sep. 24, 2009

(54) System for locating an Alzheimer's patient

(76) Inventor: Joe Garrison, Porter, IN (US)

Correspondence Address: JAMES RAY & ASSOCIATES, 2640 PITCAIRN ROAD, MONROEVILLE, PA, 15146, US

(21) Appl. No.: 12/077,310

(22) Filed: Mar. 18, 2008

(51) Int. Cl. G08B 23/00

(52) U.S. Cl. 340/573.4

(57) ABSTRACT

A wireless system for locating a patient diagnosed with Alzheimer's disease by an individual responsible for them. The system includes a locatable device worn by such patient. The locatable device includes a first control circuit having transmitting and receiving capability connected to a GPS processor with at least one pre-selected map disposed therein. The GPS processor is in wireless communication with a GPS system. A first power source is connected to the first control circuit for supplying power thereto. Further included is a handheld device having a second control circuit with transmitting and receiving capability for communicating with the first control circuit and connected to each of a keypad for entering a predetermined code to initiate a tracking request signal to the locatable device and a screen for displaying a location of the locatable device. A second power source is connected to the second control circuit for supplying power thereto.

### FIELD OF THE INVENTION

The present invention relates, in general, to various types of locating devices and, more particularly, the invention relates to a system for locating a patient who suffers from Alzheimer's disease wherein a person responsible for their care uses a handheld locating device to track a locatable device worn by the patient.

### BACKGROUND OF THE INVENTION

For elderly people suffering from Alzheimer's disease living at home under the care of loved ones, any small task can become overwhelming and confusing. It is not uncommon that soon after leaving their home they can become lost and disoriented, completely losing their way even in their own neighborhood. It may be quite some time before they are reported missing, which can be a life-threatening situation, especially when they are unable to relay their personal information to someone for assistance in returning home.

### SUMMARY OF THE INVENTION

The present invention provides a wireless system for locating a patient diagnosed with Alzheimer's disease by an individual responsible for such patient. The system includes a locatable device worn by such patient having an enclosure formed from a first predetermined material. The enclosure has each of a predetermined shape and size with a top face, a rear face and a periphery formed therebetween defining an interior space. The locatable device further has a means engageable with the enclosure for securing it about the patient. A first control circuit with transmitting and receiving capability is connected to a GPS processor having at least one pre-selected map disposed therein. The first control circuit and GPS processor are disposed in the enclosure. The GPS processor is in wireless communication with a GPS system. A first power source is connected to the first control circuit for supplying power thereto. The system further includes a handheld device formed from a second predetermined material and having each of a predetermined shape and size. The handheld device includes a housing having a top face, a rear face and a periphery formed therebetween defining an interior space. A second control circuit with transmitting and receiving capability is disposed in the housing for communicating with the first control circuit. The second control circuit is connected to each of a keypad for entering a predetermined code to initiate a tracking request signal to the locatable device and a means for displaying a location of such locatable device. The keypad and display means are disposed on the front face of the housing. Finally, a second power source is connected to the second control circuit for supplying power thereto.

### OBJECTS OF THE INVENTION

It is, therefore, one of the primary objects of the present invention to provide a system for locating an Alzheimer's patient, living at home, who becomes missing by someone responsible for their care.

Another object of the present invention is to provide a system for locating an Alzheimer's patient wherein a tracking request signal is initiated by a concerned caregiver of the patient to determine a precise geographic location of the patient.

In addition to the various objects and advantages of the present invention described with some degree of specificity above it should be understood that additional objects and advantages of the present invention will become more readily apparent to those persons who are skilled in the relevant art from the following more detailed description of the invention, particularly, when such description is taken in cojunction with the attached drawing figures and with the appended claims.

### BRIEF DESCRIPTION OF THE DRAWINGS

FIG. 1A is an exploded view of a locatable device in the form of a bracelet worn by an Alzheimer's patient used in the system of the present invention, particularly showing components disposed in the bracelet;

FIG. 1B is a front perspective view of the locatable device illustrated in FIG. 1A;

FIG. 1C is a rear perspective view of the locatable device, illustrated in FIGS. 1A and 1B, particularly showing a removable battery cover;

FIG. 2A is a front view of a handheld location device used in the system of the present invention; and

FIG. 2B is a side view of the handheld location device illustrated in FIG. 2A, particularly showing various alternative embodiments the handheld device may incorporate.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

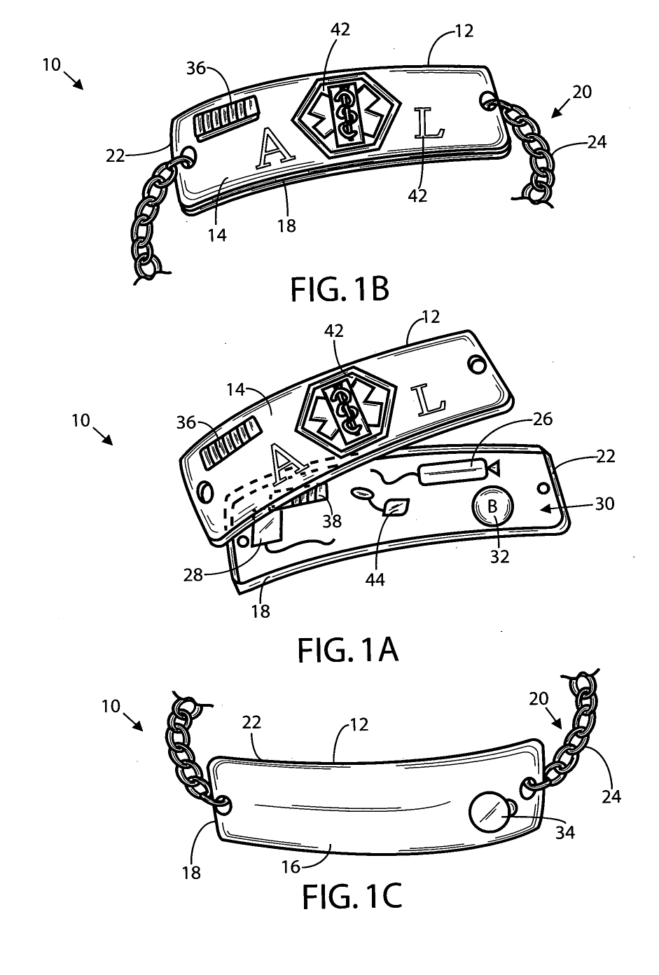

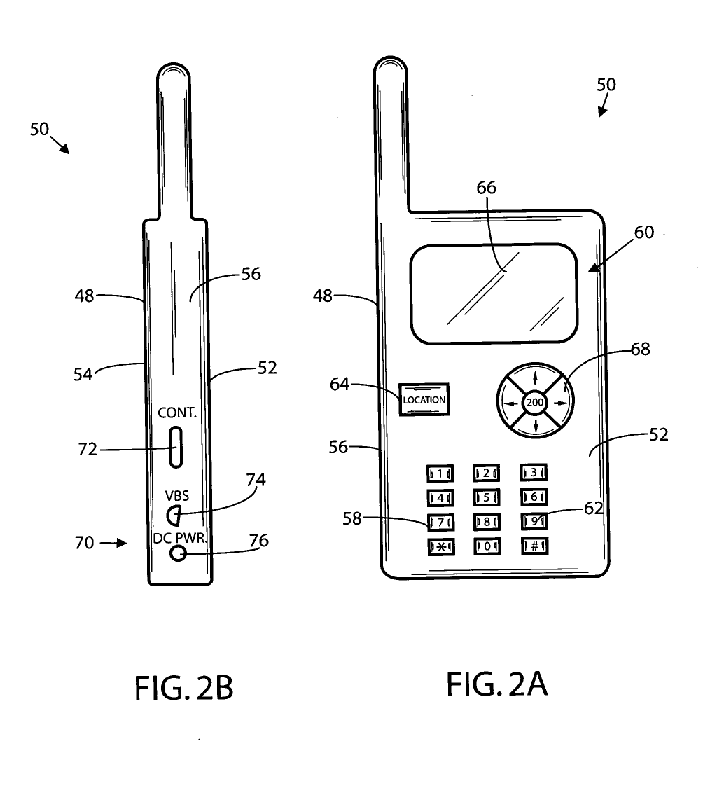

Reference is now made, more particularly, to drawing FIGS. 1-2. Illustrated therein is a wireless system for locating a patient diagnosed with Alzheimer's disease by an individual responsible for such patient. The system includes a locatable device, generally designated 10, worn by such patient having an enclosure 12 formed from a first predetermined material. Enclosure 12 has each of a predetermined shape and size with a front face 14, a rear face 16 and a periphery 18 formed therebetween defining an interior space. Locatable device 10 also has a means, generally designated 20, engageable with enclosure 12 for securing it about the patient.

Locatable device 10 may be in the form of a necklace or, preferably, a bracelet 22, as shown in FIG. 1. Preferably, the shape of enclosure 12 of bracelet 22 will be substantially arcuate to conform to a wrist of such patient. Also, means 20 engageable with enclosure 12 for securing it about the patient is preferably either a band or a chain 24, shown in FIG. 1.

Locatable device 10 further includes a first control circuit 26 having transmitting and receiving capability connected to a GPS processor 28 having at least one pre-selected map disposed therein. First control circuit 26 and GPS processor 28 are disposed in enclosure 12 with GPS processor 28 being in wireless communication with a GPS system.

Locatable device 10 still further includes a first power source, generally designated 30, connected to first control circuit 26 for supplying power thereto. Preferably, first power source 30 is a battery. The most presently preferred type of battery used will be a lithium battery 32. Also, enclosure 12 preferably includes a removable battery cover 34 disposed on rear face 16 of enclosure 12 for changing the battery when necessary.

In a presently preferred embodiment, enclosure 12 will further include a solar panel 36 and a solar charge cell 38 connected to the battery for maintaining a charge thereon.

In another preferred embodiment, enclosure 12 will further include a medical alert emblem 42 disposed on front face 14 thereof. Enclosure 12 also preferably will include an integrated strobe light 44 which illuminates medical alert emblem 42 when a tracking request signal is sent to locatable device 10 to assist in locating the patient in dark conditions.

Enclosure 12 may further include indicia 46 disposed thereon in the form of personal information including at least one of such patient's initials, name and address.

The system of the present invention further includes a handheld device, generally designated 50, formed from a second predetermined material and having each of a predetermined shape and size. Handheld device 50 includes a housing 48 having a front face 52, a rear face 54 and a periphery 56 formed therebetween defining an interior space.

Handheld device 50 has a second control circuit including transmitting and receiving capability disposed in housing 48 for communicating with first control circuit 26. The second control circuit is connected to each of a keypad 58 for entering a predetermined code to initiate a tracking request signal to locatable device 10 and a means, generally designated 60, for displaying a location of locatable device 10. Keypad 58 and display means 60 are disposed on front face 52 of housing 48.

Keypad 58 preferably includes keys having indicia 62 thereon in the form of at least one of numerals and letters for entering the predetermined code. Also, keypad 58 preferably further includes a locate key 64 which is pushed after the predetermined code is entered using the keys having at least one of numerals and letters indicia 62 thereon for initiating sending of the tracking request signal communicating the predetermined code to locatable device 10.

In a presently preferred embodiment, display means 60, includes an LCD screen 66. In addition, handheld device 50 may include a pushbutton zoom feature 68 disposed on front face 52 of the housing 48 for zooming in and out picture of location of locatable device 10 displayed on screen 66, and a dial contrast feature 72 disposed on periphery 56 of housing 48 for adjusting brightness of picture of location of said locatable device displayed on said screen. Handheld device 50 may still further include a UBS port 74 disposed on periphery 56 of housing 48 for connecting to a peripheral port of another device.

Handheld device 50 further has a second power source, generally designated 70, connected to the second control circuit for supplying power thereto. Preferably, second power source 70 is a battery. The most presently preferred type of battery used will be a rechargeable battery.

Also, it is presently preferred that handheld device 50 further include a dc power port 76 disposed on periphery 56 for connecting a charger to the rechargeable battery.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A wireless system for locating a patient diagnosed with Alzheimer's disease by an individual responsible for such patient, said system comprising:
(a) a locatable device worn by such patient including;
(i) an enclosure formed from a first predetermined material and having each of a predetermined shape and size, said enclosure having a front face, a rear face and a periphery formed therebetween defining an interior space, and
(ii) a means engageable with said enclosure for securing it about such patient;
(b) a first control circuit including transmitting and receiving capability connected to a GPS processor having at least one pre-selected map disposed therein, said first control circuit and GPS processor disposed in said enclosure, said GPS processor in wireless communication with a GPS system;
(c) a first power source connected to said first control circuit for supplying power thereto;
(d) a handheld device formed from a second predetermined material and having each of a predetermined shape and size, said handheld device including a housing having a front face, a rear face and a periphery formed therebetween defining an interior space;
(e) a second control circuit including transmitting and receiving capability disposed in said housing for communicating with said first control circuit and connected to each of a keypad for entering a predetermined code to initiate a tracking request signal to said locatable device and a means for displaying a location of said locatable device, each of said keypad and display means disposed on said front face of said housing; and
(f) a second power source connected to said second control circuit for supplying power thereto.

2. A system, according to claim 1, wherein said first power source is a battery.

3. A system, according to claim 2, wherein said battery is a lithium battery.

4. A system, according to claim 2, wherein said enclosure further includes a removable battery cover disposed on said rear face of said enclosure for changing said battery when necessary.

5. A system, according to claim 2, wherein said enclosure further includes a solar panel and a solar charge cell connected to said battery for maintaining a charge thereon.

6. A system, according to claim 1, wherein said enclosure further includes a medical alert emblem disposed on said front face thereof.

7. A system, according to claim 6, wherein said enclosure further includes an integrated strobe light for illuminating said medical alert emblem when said tracking request signal is sent to said locatable device to assist in locating such patient in dark conditions.

8. A system, according to claim 1, wherein said locatable device is in the form of one of a bracelet and a necklace.

9. A system, according to claim 8, wherein said locatable device is a bracelet and said predetermined shape of said enclosure is substantially arcuate to conform to a wrist of such patient.

10. A system, according to claim 1, wherein said means engageable with said enclosure for securing it about such patient is one of a chain and a band.

11. A system, according to claim 1, wherein said enclosure further includes indicia disposed thereon in the form of personal information including at least one of such patient's initials, name and address.

12. A system, according to claim 1, wherein said keypad disposed on said handheld device includes keys having indicia thereon in the form of at least one of numerals and letters for entering said predetermined code.

13. A system, according to claim 12, wherein said keypad further includes a locate key which is pushed after said predetermined code is entered using said keys having at least one of numerals and letters indicia thereon for initiating sending of said tracking request signal communicating said predetermined code to said locatable device.

14. A system, according to claim 1, wherein said display means includes an LCD screen.

15. A system, according to claim 14, wherein said handheld device further includes a pushbutton zoom feature disposed on said front face of said housing for zooming in and out picture of location of said locatable device displayed on said screen.

16. A system, according to claim 14, wherein said handheld device further includes a dial contrast feature disposed on said periphery of said housing for adjusting brightness of picture of location of said locatable device displayed on said screen.

17. A system, according to claim 1, wherein said handheld device further includes a UBS port disposed on said periphery of said housing for connecting to a peripheral port of another device.

18. A system, according to claim 1, wherein said second power source is a battery.

19. A system, according to claim 18, wherein said battery is a rechargeable battery.

20. A system, according to claim 19, wherein said handheld device further includes a dc power port disposed on said periphery of said housing for connecting a charger to said rechargeable battery.
